(19) United States
(12) Patent Application Publication
(10) Pub. No.: US 2009/0180498 A1
(43) Pub. Date: Jul. 16, 2009

(54) Coherent Beam Combiner Based on Parametric Conversion

(75) Inventor: Bodo Schmidt, Carlsbad, CA (US)

Correspondence Address: FITCH EVEN TABIN & FLANNERY, 120 SOUTH LASALLE STREET, SUITE 1600, CHICAGO, IL, 60603-3406, US

(73) Assignee: General Atomics, San Diego, CA (US)

(21) Appl. No.: 12/015,440

(22) Filed: Jan. 16, 2008

(51) Int. Cl. H01S 3/10

(52) U.S. Cl. 372/21

(57) ABSTRACT

Methods and systems are provided to form a single coherent beam of light from a plurality of smaller beams of light. In one implementation a beam combiner comprising a beam director is configured to direct a seed beam of coherent light and a plurality of pump beams of coherent light; and a nonlinear converter is configured to combine the seed beam and the plurality of pump beams directed by the beam director to produce a substantially coherent wave front.

### BACKGROUND OF THE INVENTION

1. Field of the Invention

The present invention relates generally to a system and method for combining multiple light beams, and more specifically to a system and method for combining multiple coherent light beams having different phases.

2. Discussion of the Related Art

A laser includes a gain medium inside an optical cavity. The optical cavity typically has opposing mirrors with one of the mirrors being partially transparent. The gain medium is supplied with electrical or optical energy from an external source. The energy is absorbed by the gain medium exciting particles to higher energy states. Particles in low energy states absorb photons and particles in high energy states release photons. When enough energy is introduced, the number of high energy particles in the gain medium exceeds the number of low energy particles and more photons are released than are absorbed and light inside the gain medium is amplified. The released photons in turn stimulate other particles producing even more light in the optical cavity. Light inside the optical cavity resonates between the opposing mirrors amplifying the light as it travels through the gain medium. Some of the resonating light escapes from the optical cavity through the partially transparent mirror producing a beam of coherent in phase light (i.e. a laser beam).

There are a number of approaches to producing a high powered coherent beam of light. One approach is to make a large high powered laser by using a large gain medium, large mirrors and supplying the laser with a large amount of external energy. A problem with this approach is that a large amount of heat is generated in the optical cavity as more particles in the gain medium are excited to higher energy states and light is amplified. The large amount of heat generated in the gain medium and problems removing the heat, effectively limits the amount of external energy/power that can be practically introduced into the optical cavity and limits the energy/power that can escape from the laser in the form of a laser beam.

Another approach to generating a high powered coherent beam of light is to generate multiple laser beams using small gain mediums and then to spatially combine the laser beams. Multiple laser beams with relatively small output apertures are placed side by side to form single beam that appears similar to a high power single aperture laser beam. This approach is a practical approach since multiple laser beams may be economically generated using multiple fiber amplifiers. The spectral property of each fiber laser forming the high power laser beam can be controlled by using a common light source. However, during amplification in the individual amplifiers, the light travels slightly different distances, depending on temperature and material variations. This leads to phase differences at the spatial combiner that must be compensated for. In the majority of schemes, some light emitted from the fiber ends is fed back to controllers that adjust a phase modulator in each arm that drives the laser outputs to a common phase. In this approach, the ends of the fiber lasers form multiple narrow light apertures that spatially combine to effectively form a single coherent beam of light composed of multiple smaller aperture beams.

Controlling the phase of each individual laser requires a controller for every laser. This phase control aspect contributes significantly to the cost, complexity and feasibility of designing a high powered laser composed of multiple smaller laser beams. Thus, there is a need for a relatively inexpensive single aperture high power laser beam formed by combining multiple smaller power laser beams. There is also a need for a system and method for combining multiple laser beams of different phases and wavelengths into a single coherent phase front. Moreover there is a need for a high power laser beam that can be formed without the need for a feedback controller.

### SUMMARY OF THE INVENTION

Embodiments of this invention address the above stated needs as well as others by providing a beam combiner comprising a beam director configured to direct a seed beam of coherent light and a plurality of pump beams of coherent light and a nonlinear converter configured to combine the seed beam and the plurality of pump beams directed by the beam director and produce a substantially coherent wave front.

Other embodiments provide a beam combiner comprising a plurality of apertures adapted to arrange a plurality of pump beams of coherent light in a pattern; a beam shaper adapted to size a seed beam; an optical element adapted to overlay the seed beam over the pattern formed by the plurality of pump beams; a nonlinear converter in optical communication with the optical surface and adapted to receive the plurality of pump beams and the seed beam from the optical element; and a rejector configured to receive light emanating from the nonlinear converter and filter a coherent wave front from an idler wave and a depleted pump wave.

Still other embodiments provide a method for generating a coherent wave front, comprising: directing a plurality of pump beams to a nonlinear converter; directing a seed beam to the nonlinear converter; and combining the seed beam with the plurality of pump beams in the nonlinear converter to produce a substantially coherent wave front.

Further embodiments provide a method for generating a coherent in phase wave front, the steps of the method comprising: arranging a plurality of pump beams of coherent light in a pattern; sizing a seed beam; substantially overlaying the seed beam over the pattern formed by the plurality of pump beams; combining the seed beam with the plurality of pump beams in a nonlinear converter to produce a coherent wave front, an idler wave and a depleted pump wave; and filtering the idler wave and the depleted pump wave away from the coherent wave front.

### BRIEF DESCRIPTION OF THE DRAWINGS

The above and other aspects, features and advantages of several embodiments of the present invention will be more apparent from the following more particular description thereof, presented in conjunction with the following drawings.

FIG. 1 is a beam combiner according to an embodiment of the present invention.

FIG. 2 shows a first exemplary embodiment of the pump lasers and pump amplifiers of the present invention.

FIG. 3 shows a second exemplary embodiment of the pump laser and pump amplifiers of the present invention.

FIG. 4 shows first exemplary embodiment of the aperture array of the present invention.

FIG. 5 shows a second exemplary embodiment of the aperture array of the present invention.

FIG. 6 shows a third exemplary embodiment of the aperture array of the present invention.

FIG. 7 shows a first exemplary embodiment of the nonlinear converter of the present invention.

FIG. 8 shows a second exemplary embodiment of the nonlinear converter of the present invention.

FIG. 9 is a method of combining coherent light beams according to an embodiment of the present invention.

Corresponding reference characters indicate corresponding components throughout the several views of the drawings. Skilled artisans will appreciate that elements in the figures are illustrated for simplicity and clarity and have not necessarily been drawn to scale. For example, the dimensions of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention.

### DETAILED DESCRIPTION

The following description is not to be taken in a limiting sense, but is made merely for the purpose of describing the general principles of exemplary embodiments. The scope of the invention should be determined with reference to the claims.

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

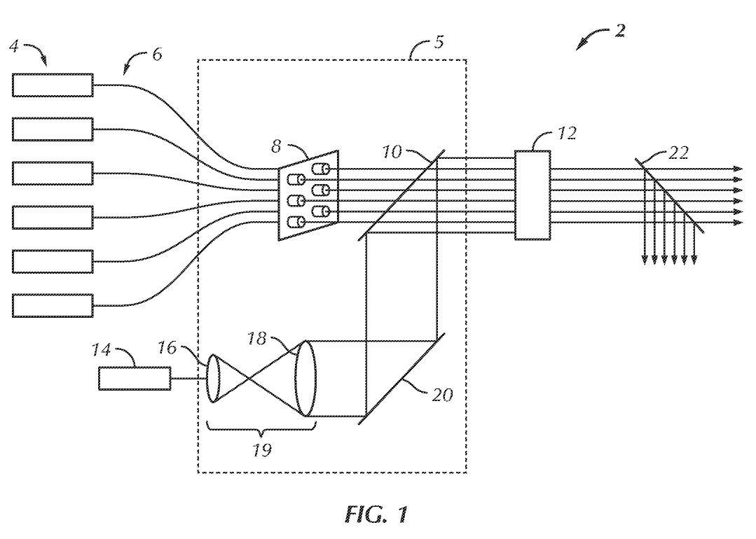

Referring first to FIG. 1, an embodiment of the invention is illustrated showing a beam combiner 2. The beam combiner 2 has a plurality of pumps 4. The plurality of pumps 4 are optically connected with an aperture array 8 through a plurality of waveguides 6 or optical beam directors. The aperture array 8 is optically aligned with an optical element 10 and a nonlinear converter 12. The nonlinear converter 12 is optically aligned with a rejector 22.

A seed laser 14 is in optical communication with a small lens 16 and a large lens 18. The small lens 16 and the large lens 18 together forming a beam shaper 19 are in turn optically coupled with a reflective surface 20. The reflective surface 20 optically couples the small lens 16 and the large lens 18 with the optical element 10. The optical element 10 is aligned with the nonlinear converter 12. The nonlinear converter 12 has an output optically aligned with a rejector 14. The aperture array 8, beam combiner 19, the reflective surface 20 and the optical element 10 form a beam director 5.

Generically, the beam director 5 is any structure that acts to direct the pump beams and seed beam to the nonlinear converter 12 such that the pump beams are substantially contained within the envelope of the seed beam. It is understood that such structure may include any one or more of aperture arrays, beam combiners, reflective surfaces and other optical elements.

Each of the plurality of pumps 4 generates laser light of a similar wavelength, each pump generating laser light having a wavelength within the acceptance bandwidth of the nonlinear converter. The laser light from each of the pumps is conducted through a plurality of waveguides 6 or optical beam directors. Each waveguide terminates at a respective aperture in the aperture array 8. Each of the apertures in the aperture array 8 is aligned to project light from the apertures through the optical element 10 and onto the nonlinear converter 12. The light emanating from each of the apertures in the aperture array 8 is directed onto different surface areas of the nonlinear converter 12.

The seed laser 14 generates a seed beam having a wavelength different from the laser light emitted from the plurality of pumps 4. The seed laser beam is spatially sized through the small lens 16 and the large lens 18. After the seed beam is sized, the reflective surface 20 projects the seed beam toward the optical element 10. The optical element 10, in turn, reflects the light toward the nonlinear converter 12. The seed beam at the nonlinear converter 12 substantially overlays the laser light generated from the plurality of pumps 4. The nonlinear converter 12 mixes the seed beam with the light from the plurality of pumps 4. Inside the nonlinear converter three-wave mixing occurs (explained hereinafter). The three-wave mixing produces a single phase output wave-front, an idler wave and a depleted pump wave. The light emitted from the nonlinear crystal is then filtered by rejector 22. The rejector 22 rejects the idler wave and the depleted pump waves leaving a single phase output wave front (not shown).

In this embodiment, there is a plurality of pumps 4. Each pump supplies power to the single phase output wave front (signal). Any number of pumps may be used to pump the power in the output wave front to a desired power level. The term laser is used to describe the coherent light emitted from the each of the plurality of pumps. In this context, laser light is not limited to the visible spectrum and may have wavelength of 1064 nm for example. Those skilled in the art will appreciate that there are many appropriate choices for pump wavelengths and that an appropriate choice for pump wavelength is often application dependent.

The output of the plurality of pumps 4 emitting light of a common wavelength are connected to a plurality of waveguides 6 in this embodiment. The plurality of waveguides 6 may be a fiber optic cable for example. In alternate embodiments the plurality of waveguides 6 may be omitted with laser light propagating through free space or air. In alternate embodiments, the plurality of pumps 4 emits light having two or more distinct wavelengths.

In this embodiment, the aperture array 8 includes six apertures arranged in a two dimensional grid for directing light. Alternate embodiments feature other types of aperture arrays having more or less than six apertures. Alternate embodiments feature aperture arrays 8 having apertures arranged in a variety of topologies.

The seed laser 14 generates a beam having a wavelength different than the beams generated by the plurality of pumps 4. The seed laser 14 may generate laser beams in a variety of modes including a single longitudinal mode, a multi longitudinal mode, a mode locked mode or equivalent. Emitted laser light is not limited to the visible electromagnetic spectrum. Emitted laser light may for example have wavelength of 1550 nanometers (nm). The wavelength of the seed laser 14 is application dependent since the wavelength of the seed laser determines the wavelength of the coherent wave front generated in the nonlinear converter 12.

In this embodiment, the seed laser beam is sized and projected onto the nonlinear converter through the beam shaper 19, the reflective surface 20 and the optical element 10. Those skilled in the art will recognize there are many alternative structures for sizing and projecting the seed beam onto the nonlinear converter 12. Alternate embodiments, for example, may have more or less lenses, optical elements, reflective surfaces or other optical structures performing these functions. Projecting the seed beam directly onto the non-linear converter 12 is also contemplated.

Optical element 10 may have different optical properties for different wavelengths. Laser beams having wavelengths of the seed beam and the plurality of pump beams may behave differently when they illuminate portions of the optical element 10. Alternate embodiments feature an optical element 10 having similar optical properties for laser beams having wavelengths of the seed beam and the plurality of pump beams. Thus, the optical element 10 reflective and transmissive characteristics may or may not be wavelength dependent.

In one embodiment, the nonlinear converter 12 is a nonlinear crystal. The nonlinear crystal is chosen to have bandwidth acceptance that will accept the seed beam and the plurality of pump beams. The plurality of pumps 4 of this embodiment might for example generate a plurality of laser beams each having wavelengths of 1064 nm. The seed laser might generate a seed beam having a wavelength of 1550 nm. The bandwidth acceptance of the nonlinear crystal would include these wavelengths. Although a nonlinear crystal is used in this embodiment, alternate embodiments feature other structures having nonlinear transfer functions.

Three-wave mixing, a parametric process, occurs inside the nonlinear converter 12 according to several embodiments. For example, when pump lasers having wavelengths of 1064 nm and a seed laser having a wavelength of 1550 nm are mixed in the nonlinear converter 12, a coherent output wave front having a wavelength of 1550 nm is generated. An idler wave having a wavelength of about 3393 nm is also generated. The idler wave picks up the phase differences between each of the plurality of pump waves and the seed wave. A depleted pump wave of 1064 nm is also a residue of the mixing process.

Those skilled in the art will recognize that three wave mixing occurs without the need for tuning the phases of the plurality of pump beams. This is because the nonlinear process occurs in separate apertures and the phase differences in neighboring apertures do not affect each other. This eliminates the need for a feedback loop for each of the plurality of pump beams according to several embodiments. Since mixing occurs regardless of the relative phases of each of the plurality of pump beams, relatively inexpensive waveguides for directing the plurality of pump beams may be used.

A number of crystals are suitable for use as a nonlinear converter. In some embodiments the selected crystal should have a “phase-matching” condition to effectively mix the three wavelengths. There are a number of ways to achieve phase-matching. One common approach is to use the angular dependency of the refractive index of the crystal. Another approach is to temperature tune the crystal. Still another approach is periodic poling of the crystal to achieve quasi phase-matching.

To achieve three-wave mixing, pump lasers having wavelengths of 1064 nm and a seed laser having a wavelength of 1550 may be used. A KTP crystal or a KTP crystal isomorph such as KTA, RTP and RTA may be used as the nonlinear converter. Those skilled in the art will recognize there are many other suitable crystals that may also be used to achieve phase matching for these exemplary wavelengths, for example LiNbO3.

Those skilled in the art will recognize that the idler wave wavelength is the reciprocal of the difference of the reciprocals of the wavelength of the plurality of pump beams and the seed beam. Thus, the wavelengths of the seed beam and the plurality of pump beams may be appropriately selected to generate idler and depleted pump waves that may easily be separated from the coherent wave front.

It should be recognized that the crystal may be chosen based on the application. For example, high power applications may require good absorption characteristics making KTA and RTA good crystal choices. Different crystals absorb light differently at different wavelengths. In some embodiments, the crystal is selected based on absorption characteristics. For example, with a 1064 nm pump laser and 1550 nm seed both KTA and KTP crystals absorb the idler wave. KTA, however, better transmits the idler making it a better choice for some applications.

For many embodiments in which phasematching is needed, the selected crystals have to match a “phasematching” condition to effectively mix the three wavelengths. Phasematching may be achieved by exploiting the common angular dependency of the refractive index. The goal is to make sure that the momentum of the three mixing waves is conserved. The momentum is defined as the k-vector of the wave and is inverse proportional to the refractive index, so by picking the right refractive index momentum conservation may be achieved. Phasematching may also be further refined by refinement techniques such as temperature tuning.

Another approach to phase matching is to periodically pole a crystal to achieve quasi-phasematching. Those skilled in the art will recognize the importance of quasi phase matching as another technique to achieve effective three wave mixing.

For some embodiments there are a limited number of suitable crystals to achieve phase matching for a given combination of pump, signal and idler wavelengths. For other embodiments a couple of dozen crystals will work well. For example, with a 1064 nm pump, 1550 nm seed and a 3400 nm idler wave some exemplary suitable crystals are KTP crystals and their isomorphs, such as KTA, RTP and RTA, but other crystals may be used as well, for example LiNbO3.

For many applications, other parameters also come into play such as the absorption characteristics of the crystal for all wavelengths involved, the magnitude of the conversion coefficient, walk-off and other parameters. Alternate embodiments feature different crystals with different parameters making them suitable for a variety of applications.

For example, in high-power applications absorption is very important parameter. Many high power embodiments feature KTA and RTA crystals as well as LiNbO3 crystals because of their absorption characteristics. Many high power embodiments also feature KTA crystals and KTP crystals because of their large aperture sizes that allow overlap of a seed beam over many pump beams. The availability of these crystals also make them a good choice for many high power applications.

In some embodiments, the nonlinear converter 12 has an output surface scaled and shaped as desired to create a virtual aperture for the coherent wave front. Moreover, light emanating from the nonlinear converter may also be further focused or directed using other optical elements. Formation of directed energy beams power scaled and sized for specific applications is also contemplated.

In some embodiments, a rejector 22 such as a dichroic filter is used to separate the idler and depleted pump waves from the coherent wave front. Alternate embodiments feature other types of filters. Embodiments without any filters are also contemplated.

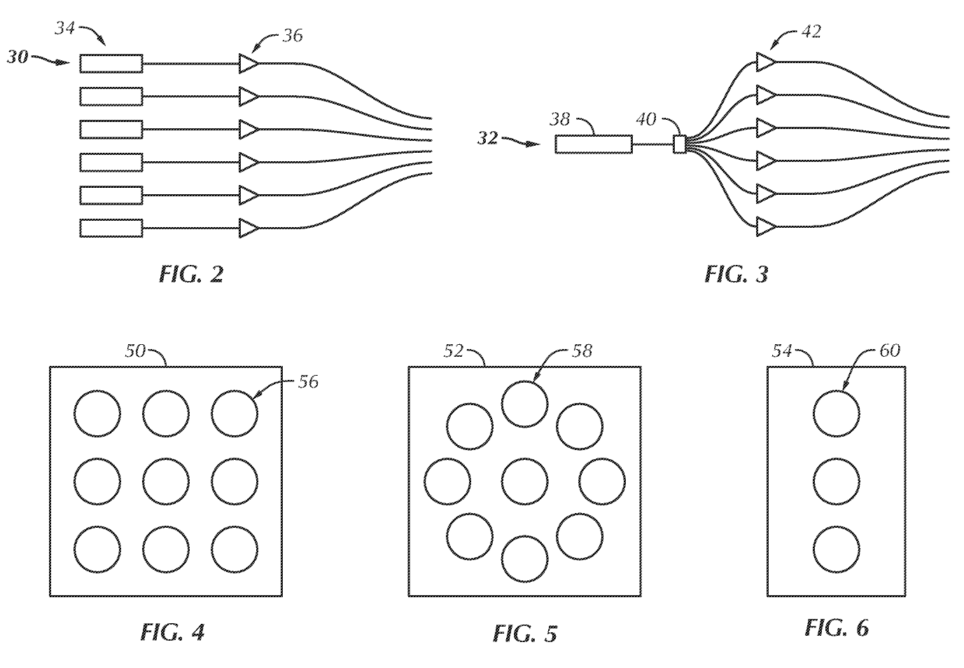

Referring next to FIG. 2 and FIG. 3, two exemplary embodiments of the pump lasers and amplifiers are shown. The first embodiment illustrated in FIG. 2 shows a distributed pump laser system 30 and the second embodiment shows a common source pump laser system 32. These pump laser systems are featured in alternative embodiments of the plurality of pump lasers 4 shown in FIG. 1. FIG. 3 shows a plurality of pump beams that do not emanate from a common source and because of this the wavelengths (or spectral properties) of each pump beam can vary significantly.

The distributed pump laser system 30 has a plurality of pump lasers 34 each pump laser operating as an oscillator and a plurality of pump laser amplifiers 36. In the distributed pump laser system 30, each of the plurality of pump lasers 34 generates a laser beam that is amplified.

In this embodiment, amplification of the pump lasers occurs after generation of the laser beam. Amplification may take place for example in an optical fiber. Amplification in alternate embodiments may take place in the gain medium of the plurality of pump lasers 34 or in an external (free space) amplifier 36.

The common source pump laser system 32 illustrated in FIG. 3 has a single laser 38 operating as a single master oscillator. Light emitted from the laser 38 is split by a splitter 40 into a plurality of light beams. The plurality of light beams is then amplified by a plurality of amplifiers 42. In this embodiment, the spectral characteristics of each the laser beams is similar. The common source pump laser system 32 may also be combined with a distributed pump laser system 30 to provide a hybrid laser system.

In either embodiment, a pulsed laser waveform may be used. The pulses emanating from the lasers may be shaped to match the transfer characteristics or input requirements of the beam combiner or optical elements of the beam combiner such as the nonlinear converter. Alternate embodiments feature continuous wave (CW) lasers.

Referring next to FIGS. 4-6, exemplary embodiments of a pump laser aperture are shown. The first embodiment is a grid array 50, the second embodiment is a circular array 52 and third embodiment is a linear array 54. These pump laser apertures are featured in alternative embodiments of the beam combiner 2.

The grid array 50 illustrated in FIG. 4 has nine circular apertures 56 arranged as a grid. The apertures may be fed with laser beams from fiber or other wave guides. The use of a free-space coupled array is also contemplated. Each of the nine circular apertures 56 is aligned to direct light emanating from the apertures as collimated light toward a nonlinear converter. Alternate embodiments may feature apertures that direct each light toward predetermined portions of the nonlinear converter. It can be appreciated that the number of apertures in the grid array 50 may be increased or decreased to accommodate more or less laser beams.

The circular array 52 illustrated in FIG. 5 has nine circular apertures 58 arranged in a circular array. Like the grid array the apertures may be fed with laser beams from fiber or other waveguides. The grid array may also be fed with beams coupled through free space. The nine circular apertures 58 are aligned to direct the light emanating from the apertures as collimated light toward a nonlinear converter 12.

The linear array 54 illustrated in FIG. 6 has three circular apertures 60 arranged in a line. Each aperture is also fed with laser beams. Light emanating from the linear array may also be focused on the nonlinear converter 12. It can be appreciated that there are many suitable topologies for aperture arrays. The use of noncircular apertures in the aperture array is also contemplated.

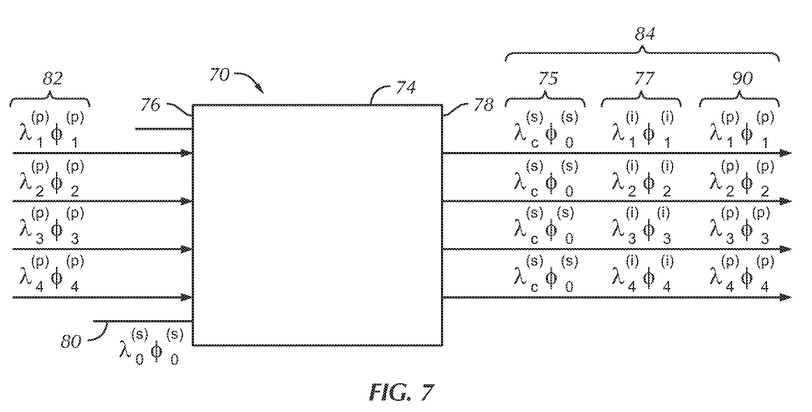

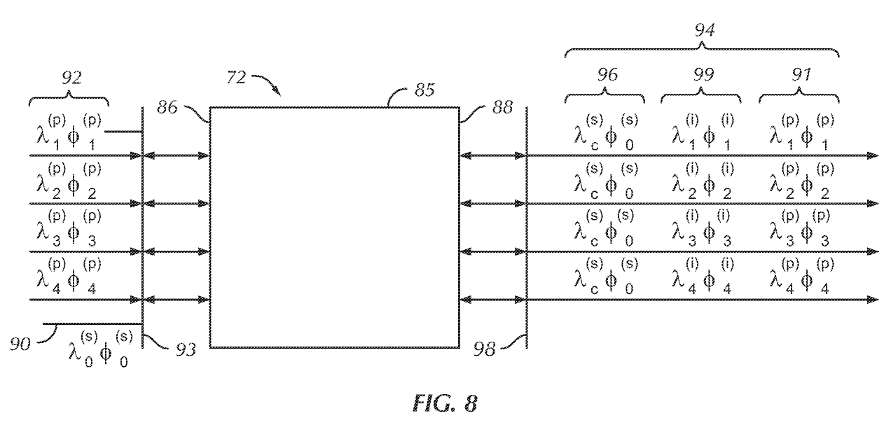

Referring next to FIGS. 7-8, two exemplary embodiments of a nonlinear converter are shown. The first embodiment illustrated in FIG. 7 shows an optical parametric amplifier (OPA) 70 and the second embodiment shows an optical parametric oscillator (OPO) 72. The nonlinear converters illustrated are two example embodiments of the nonlinear converter 12 shown in FIG. 1.

An exemplary OPA 70 embodiment includes a nonlinear crystal 74 with an input surface 76 and an output surface 78. The input surface 76 is configured to receive a seed beam 80 having wavelength λ₀^{(s)} and phase φ₀^{(s)}. The input surface 76 is also configured to receive a plurality of pump beams 82 having one or more wavelengths, λₙ^{(p)} where n corresponds to each pump beam, substantially contained within the temporal and spatial envelope of the seed beam 80. The pump beams 82 may have any phase φₙ^{(p)} where n corresponds to each pump beam. The output surface 78 is configured to output waveform 84 including coherent wave front 75, idler wave 77 and depleted wave 90. The coherent wave front 75 having a wavelength of λ_{c}^{(s)} and phase angle λ₀^{(s)}, the idler wave 77 having wavelengths λₙ⁽ⁱ⁾ and phase angles φₙⁱ and the depleted pump wave 90 having wavelengths λₙ⁽ⁱ⁾ and phase angles φₙ^{(p)}.

An exemplary OPO 72 embodiment illustrated in FIG. 8 includes a nonlinear crystal 85 with an input surface 86 and an output surface 88. The input surface 86 is configured to receive a seed beam 90 having wavelength λ₀^{(s)} and phase λ₀^{(s)}. The input surface 86 is also configured to receive a plurality of pump beams having one or more wavelengths, λₙ^{(p)} where n corresponds to each pump beam, substantially contained within the temporal and spatial envelope of the seed beam 90. The pump beams 92 may have any phase angle φₙ^{(p)} where n corresponds to each pump beam. The output surface 88 is configured to output waveform 94 having a coherent wave front 96 having a wavelength of λ_{c}^{(s)} and phase angle φ₀^{(s)}. The output surface 88 also outputs an idler wave 99 having wavelengths λₙ⁽ⁱ⁾ and phase angles φₙⁱ and a depleted pump wave 91 having wavelengths λₙ^{(p)} and phase angles φₙ^{(p)}. The OPO 72 also includes a mirrored surface 93 for reflecting light emitted from the nonlinear crystal 85 back into the nonlinear crystal 85. A partially mirrored surface 98 reflects some of the light emitted from the nonlinear crystal back into the nonlinear crystal 85 and allows some light to pass there through. The mirrored surface 93 and the partially mirrored surface 98 reflect waves back and forth through a cavity volume formed by mirrored surfaces 93, 98 allowing more thorough mixing. This often results in more efficient conversion of pump energy into a coherent wave front. It is also contemplated to make the partially reflective surface 98 reflective for the pump wavelength to increase conversion efficiency.

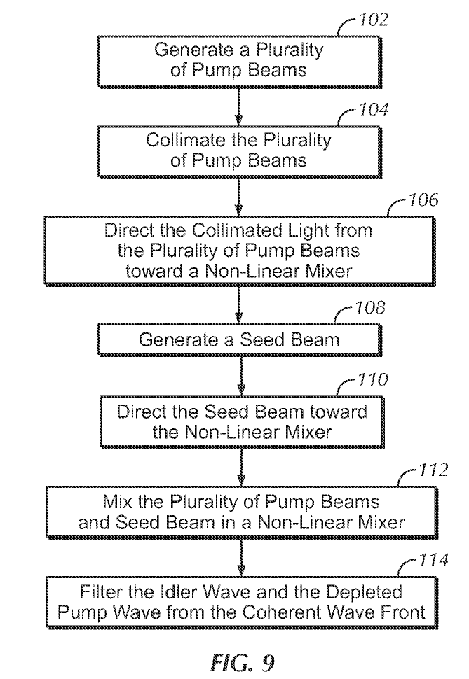

Referring next to FIG. 9, an embodiment of a method for combining coherent light beams is illustrated. In several embodiments the method may performed using the system of FIG. 1. According to the method a plurality of pump beams are generated (Step 102). The pump beams are laser light that may be generated using a fiber optic laser for example. The pump beams may be generated from a common laser or multiple lasers. The pump beams may be amplified in the laser medium or may be amplified after departing the laser cavity. The phase of the laser beams need not be the same. Also, the wavelength of the laser beams need not be the same, as long as it is wavelength is within the acceptance bandwidth of the nonlinear converter.

The plurality of laser beams are then collimated (Step 104). The laser beams may be collimated with an aperture array or may be aligned. The collimated light emanating from the laser beams need not be perfectly parallel but should be directed so that the light may be received by a nonlinear converter such as a crystal or nonlinear mixer. The collimated light should be configured to distribute energy over an input surface area.

The collimated light from the plurality of pump beams is then directed toward a nonlinear mixer (Step 106).

A seed beam is generated (Step 108). The seed beam should have the wavelength of the desired output wave front. The seed beam may be sized to overlay the collimated light from the plurality of laser beams. The seed beam may also be sized with one or more lenses (e.g., a beam shaper).

The seed beam is directed toward the nonlinear mixer (Step 110). The seed beam may be directed using reflective surfaces or other optical components. In several embodiments steps 102-106 are performed in parallel with steps 108 and 10.

The plurality of pump beams and seed beams may then be mixed in a nonlinear mixer (Step 112). The nonlinear mixer may be a crystal for example that produces three-wave mixing, such as those described herein. The pump beams and the seed beams generate a coherent wave front. The coherent wave front is at the same wavelength as the plurality of the seed beams. An idler wave is also generated. The idler wave picks up the phase difference in the plurality of pump beams. A depleted pump wave is also a residue of the mixing process. The idler wave and the depleted pump wave are of different wavelengths than the coherent wave front.

Next, the idler wave and the depleted pump wave are filtered away from the coherent wave front (step 114). This filtering may be performed using a rejector or dichroic element. After filtering, a coherent wave front remains, generated from a seed beam and a plurality of pump beams having different phases. Furthermore, it is noted that in accordance with several embodiments, beam combining is provided without the need for feedback control.

While the invention herein disclosed has been described by means of specific embodiments, examples and applications thereof, numerous modifications and variations could be made thereto by those skilled in the art without departing from the scope of the invention set forth in the claims.

What is claimed is:

1. A beam combiner comprising:
a beam director configured to direct a seed beam of coherent light and a plurality of pump beams of coherent light; and
a nonlinear converter configured to combine the seed beam and the plurality of pump beams directed by the beam director and produce a substantially coherent wave front.

2. The beam combiner of claim 1 wherein at least two of the plurality of pump beams have different phases.

3. The beam combiner of claim 1 wherein the nonlinear converter also produces an idler wave and a depleted pump wave.

4. The beam combiner of claim 1 wherein beam director is adapted to direct the seed beam and the plurality of pump beams to arrive at the nonlinear converter from substantially the same direction.

5. The beam combiner of claim 1 wherein the nonlinear converter comprises a crystal that facilitates three-wave mixing.

6. The beam combiner of claim 1 further comprising a plurality of mirrored surfaces such that the nonlinear converter operates as an optical parametric oscillator.

7. The beam combiner of claim 1 wherein the nonlinear converter is an optical parametric amplifier.

8. The beam combiner of claim 1 wherein the beam director comprises an array of apertures for arranging the plurality of pump beams in a pattern.

9. The beam combiner of claim 1 further comprising a rejector for redirecting an idler wave front and a depleted pump wave front also produced by the nonlinear converter away from the substantially coherent in-phase wave front.

10. The beam combiner of claim 1 wherein the nonlinear converter is a crystal that allows phasematching of the substantially coherent wave front with a pump wave and an idler wave.

11. The beam combiner of claim 1 wherein the seed beam is generated by a laser that is configured to operate in a mode selected from a group of modes consisting of a single longitudinal mode, a multi longitudinal mode and a mode locked mode.

12. The beam combiner of claim 1 wherein the beam director is adapted to direct the plurality of pump beams and the seed beam such that the plurality of seed beams are substantially contained within a temporal and spatial envelope of the seed beam.

13. The system of claim 1 wherein each of the plurality of pump beams has a respective beam envelope that is smaller than an envelope of the seed beam.

14. A beam combiner comprising;
a plurality of apertures adapted to arrange a plurality of pump beams of coherent light in a pattern;
a beam shaper adapted to size a seed beam;
an optical element adapted to overlay the seed beam over the pattern formed by the plurality of pump beams;
a nonlinear converter in optical communication with the optical surface and adapted to receive the plurality of pump beams and the seed beam from the optical element; and
a rejector configured to receive light emanating from the nonlinear converter and filter a coherent wave front from an idler wave and a depleted pump wave.

15. A method for generating a coherent wave front, comprising:
directing a plurality of pump beams to a nonlinear converter;
directing a seed beam to the nonlinear converter; and
combining the seed beam with the plurality of pump beams in the nonlinear converter to produce a substantially coherent wave front.

16. The method of claim 15 wherein at least two of the plurality of pump beams have different phases.

17. The method of claim 15 wherein the combining step also produces an idler wave and a depleted pump wave.

18. The method of claim 15 wherein the seed beam and the plurality of pump beams arrive at the nonlinear converter from substantially the same direction.

19. The method of claim 15 wherein the combining step comprises combining the seed beam with the plurality of pump beams in the nonlinear converter that facilitates three-wave mixing.

20. The method of claim 15 further comprising:
operating the nonlinear converter as an optical parametric oscillator.

21. The method of claim 15 further comprising:
operating the nonlinear converter as an optical parametric amplifier.

22. The method of claim 15 wherein the directing step further comprises:
arranging the plurality of pump beams in a pattern with an aperture array.

23. The method of claim 15 further comprising:
generating the plurality of pump beams and generating the seed beam.

24. The method of claim 15 further comprising:
directing an idler wave front and a depleted pump wave front away from the substantially coherent wave front.

25. A method for generating a coherent in phase wave front, the steps of the method comprising:
arranging a plurality of pump beams of coherent light in a pattern;
sizing a seed beam;
substantially overlaying the seed beam over the pattern formed by the plurality of pump beams;
combining the seed beam with the plurality of pump beams in a nonlinear converter to produce a coherent wave front, an idler wave and a depleted pump wave; and
filtering the idler wave and the depleted pump wave away from the coherent wave front.
